(19) United States
(12) Patent Application Publication
(10) Pub. No.: US 2021/0045576 A1
(43) Pub. Date: Feb. 18, 2021

(54) CONTROL UNIT FOR ACTIVELY HEATED OR COOLED DRINKWARE AND DISHWARE

(71) Applicant: Ember Technologies, Inc., Westlake Village, CA (US)

(72) Inventors: Clayton Alexander, Westlake Village, CA (US); Christopher Thomas Wakeham, Solana Beach, CA (US); Frank Victor Baumann, San Diego, CA (US); Yunpu Chang, Westlake Village, CA (US); Clifton Texas Lin, San Diego, CA (US); Daren John Leith, Agoura Hills, CA (US); Mikko Juhani Timperi, San Marcos, CA (US); Thomas Albert Tejada, Venice, CA (US)

(21) Appl. No.: 16/963,481

(22) PCT Filed: Jan. 18, 2019
(86) PCT No.: PCT/US2019/014230

§ 371 Date: Jul. 20, 2020

Related U.S. Application Data
(60) Provisional application No. 62/629,976, filed on Feb. 13, 2018.
(60) Provisional application No. 62/671,952, filed on May 15, 2018.

(51) Int. Cl. A47J 36/24; A47J 39/02; H04L 29/08

(52) U.S. Cl. CPC A47J 36/24; A47J 2202/00; H04L 67/125; A47J 39/02

(57) ABSTRACT

A control unit for an actively heated or cooled drinkware, dishware or serverware device has a base with a surface that receives the actively heated or cooled drinkware, dishware or serverware device thereon, and a visual display. The control unit has circuitry configured to communicate with the visual display. The circuitry is operable to perform one or more of: send a data request signal to the device, receive one or more data from device, receive one or more operating parameter setpoints from a user, send the one or more operating parameter setpoints to the device to set a new target value for the one or more operating parameter setpoints at which the device is to operate, and communicate at least one of the one or more data to the visual display to display said at least one data on the visual display.

### BACKGROUND

### Field

The invention is directed to actively heated or cooled drinkware, dishware or serverware, and more particularly to a control unit for use with such actively heated or cooled drinkware, dishware or serverware.

### Description of the Related Art

Conventional drinkware, dishware and serverware are well known and used at home, in restaurants and cafes. However, conventional drinkware, dishware and serverware are passive in that they do not operate to maintain the beverage or food placed on them at a desired temperature, resulting in the beverage or food cooling (in the case of warm drinks/food) or warming (in the case of cold drinks/food) after a short period of time, making the drinking and eating experience unsatisfactory.

Further, in restaurants and cafes it is common to deliver the food to the consumer a period of time after the food was prepared and placed on the dishware, for example to serve meals to multiple guests at the same time, which may result in some meals having sat in the kitchen for a longer period of time after being prepared, during which the temperature of the meal may have changed significantly, leading to an unsatisfactory eating experience for the consumer. Similarly, in hotels room service delivery of food to hotel guests often occurs some period of time after the food was prepared and placed on the dishware, resulting in in some meals having sat in the kitchen for a longer period of time after being prepared, or for delays between when the food was prepared and when delivered by room service to the hotel guest, during which the temperature of the meal may have changed significantly, leading to an unsatisfactory eating experience for the hotel guest.

### SUMMARY

There is a need for actively heated or cooled drinkware (e.g., cups, mugs, liquid containers), dishware (e.g., plates, bowls) and serverware (e.g., platters, soup tureens) that are operable to maintain the beverage or food placed on them at a desired temperature for an extended period of time, allowing users to consume the beverage or food at the desired temperature for the entire drinking or eating experience (e.g., for the entire meal). With respect to hotels (e.g., hotel kitchens), restaurants (e.g., in hotels) and cafes, there is a need for actively heated dishware and plateware that can maintain the temperature of food placed on the dishware and plateware at a desired temperature (e.g., desired serving temperature), between the time the food is prepared and placed on the dishware or plateware and the time when the food is served to the consumer so the consumer receives their meal at the desired temperature (e.g., even if some meals are served or delivered a longer period of time after being prepared in order to serve multiple meals at the same time in the case of a large diner party).

Further, there is a need for a control unit for readily and easily controlling the temperature to which the actively heated dishware, drinkware or plateware heats or cools the food or beverage placed thereon (e.g., to coincide with the temperature the food should be served at to enhance the eating/drinking experience). In particular, where multiple units of dishware, drinkware or plateware are to be used, such as in a restaurant or café, or at a dinner event, the control unit can be used by one person to easily set or change the desired operating temperature for multiple units (e.g., sequentially). Additionally, where different foods are to be served, each requiring a different serving temperature to enhance (e.g., maximize) the eating experience, the control unit can be used to easily set or change the desired operating temperature for multiple units, such as plates, cups, bowls (e.g., sequentially) to enhance (e.g., maximize) the eating or drinking experience by the end user or guest of their particular dish or drink once the food or drink is consumed.

In accordance with one aspect, a control unit for an actively heated or cooled drinkware, dishware or serverware device is provided. The control unit comprises a base having a surface configured to receive the actively heated or cooled drinkware, dishware or serverware device thereon and a visual display. The control unit further comprises circuitry configured to communicate with the visual display, the circuitry being operable to perform one or more of: send a data request signal to the device, receive one or more data from device, receive one or more operating parameter setpoints from a user, send the one or more operating parameter setpoints to the device to set a new target value for the one or more operating parameter setpoints at which the device is to operate, and communicate at least one of the one or more data to the visual display to display said at least one data on the visual display.

In accordance with another aspect, the control unit described above is incorporated into a table stand or counter surface.

In accordance with another aspect, the control unit described above is incorporated into a beverage preparation and dispensing machine.

### BRIEF DESCRIPTION OF THE DRAWINGS

FIG. 1 is a schematic perspective view of a control unit with an actively heated or cooled drinkware container (e.g., cup, mug) disposed on a base of the control unit.

FIG. 2 is a schematic perspective view of another control unit with an actively heated or cooled drinkware container (e.g., cup, mug) disposed on a base of the control unit.

FIG. 3 is a schematic perspective view of another control unit with an actively heated or cooled drinkware container (e.g., cup, mug) disposed on a base of the control unit.

FIG. 4 is a schematic perspective view of another control unit.

FIG. 5 is a system block diagram of a control unit.

FIGS. 6-8 are flowcharts of the communication protocol between the control unit and an actively heated or cooled drinkware container (e.g., cup, mug) placed on the control unit.

FIG. 9 is a schematic perspective view of a control unit incorporated into a table, counter or other surface and configured to receive an actively heated or cooled drinkware container thereon.

FIG. 10 shows a control unit incorporated into a beverage preparation and/or dispensing machine.

### DETAILED DESCRIPTION

Disclosed herein are implementations of a control unit for use with an actively heated or cooled unit of dishware, drinkware or serverware to set or change a temperature setpoint at which said unit of dishware, drinkware or serverware is to operate (e.g., between the time the food thereon or drink therein is prepared and the time the food or drink is finally consumed). Though the drawings and descriptions below may refer to a particular form factor for drinkware, such as a cup or mug, the disclosed control unit implementations can also be used with any form factor for drinkware, dishware and serverware and such use is contemplated herein and falls under the scope of this invention. Drinkware includes cups, mugs (e.g., travel mugs, beer mugs, coffee mugs), liquid containers (e.g., water containers), baby bottles, carafes, wine glasses, such as handheld containers used by consumers to consume a beverage. Dishware includes plates and bowls, etc. Serverware includes platters, soup tureens, etc.

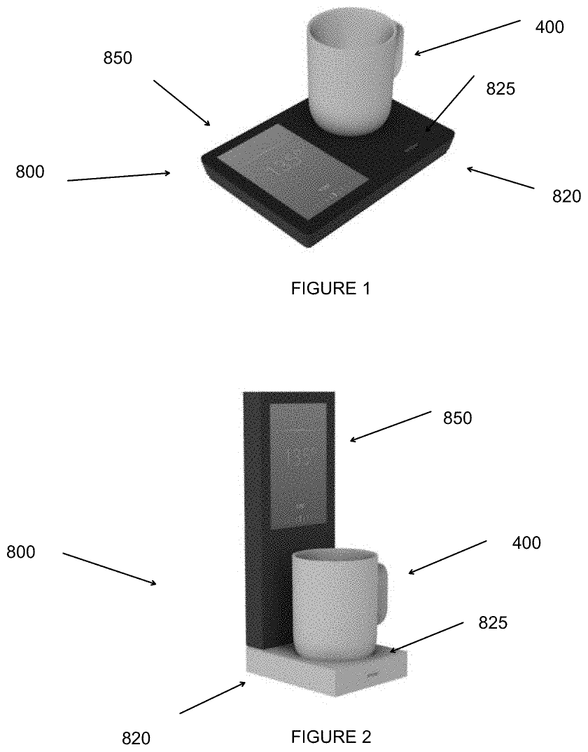

FIGS. 1-4 show different form factors for a control unit 800 for use with actively heated or cooled drinkware, dishware or plateware. In particular, FIGS. 1-4 show a control unit 800 for use with an actively heated or cooled device or drinkware container (e.g., cup or mug) 400. However, as discussed above, a control unit having a similar construction and operation as shown in these figures and described herein can be used with any other unit of actively heated or cooled drinkware, dishware or plateware. The actively heated or cooled device or drinkware container (e.g., cup or mug) 400 can have one or more heating or cooling elements, circuitry for controlling the operation of the one or more heating or cooling elements, optional batteries for providing power to one or both of the circuitry and/or heating or cooling elements, and optional sensors for sensing one or more parameters (e.g., temperature, liquid level) of the contents in the mug or cup and communicating a signal corresponding to the one or more sensed parameters to the circuitry. Further details of actively heated cups or mugs, or more generally actively heated or cooled drinkware, dishware or serverware, can be found in U.S. Pat. Nos. 9,814,331 and 9,801,482, which are incorporated herein by reference in their entirety and should be considered a part of this specification.

The control unit 800 includes a base 820 with a surface 825 on which the actively heated or cooled unit (e.g., actively heated or cooled drinkware, dishware or serverware unit) can be placed to set or change (e.g., to program) the desired temperature or temperature range for operation of the unit. Optionally, the control unit 800 can also have a visual display 850. Optionally, the visual display 850 can be a touch screen (e.g., capacitive touch screen) and serve as a user interface via which the user can select the desired temperature or temperature range for operation of the unit. As shown in FIGS. 1-4, the visual display 850 can display a temperature value and optionally display a temperature scale to display the selected temperature or temperature range. The control unit 800 (e.g., the control unit of FIGS. 1-4) can be powered by a single wall adaptor (e.g., a 19 V, 2.1 A adaptor). In another implementation, the control unit 800 can have one or more batteries to power the visual display 850 and communication with the actively heated or cooled device, such as drinkware container (e.g., cup or mug) 400, as further described below. The user interface can be operated, as disclosed further below.

FIG. 1 shows a control unit 800 that extends along a single plane, where the visual display 850 is generally coplanar (e.g., extends along the same plane or a parallel plane) with a base surface 825 that receives the actively heated or cooled unit (e.g., drinkware container, plate ware, serverware). Optionally, the visual display 850 can be adjacent the base surface 825. The visual display 850 and base 820 are part of a single integral unit.

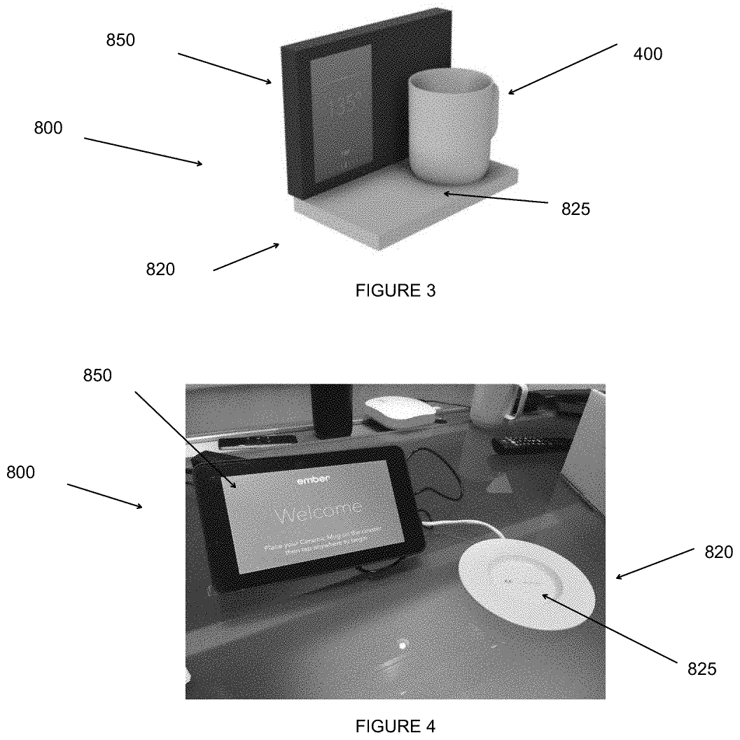

FIG. 2 shows a control unit 800 that extends along two planes, where the visual display 850 extends along a plane that is generally transverse (e.g., perpendicular) to a plane with a base surface 825 that receives the actively heated or cooled unit, such as drinkware container (e.g., cup or mug 400). The visual display 850 and base 820 are part of a single integral unit. The visual display 850 can optionally be spaced above the base 820 by an amount that allows the display 850 to be viewed while the actively heated or cooled cup or mug 400 is disposed on the base 820, the visual display 850 optionally disposed above the top end of the drinkware container (e.g., cup, mug) 400.

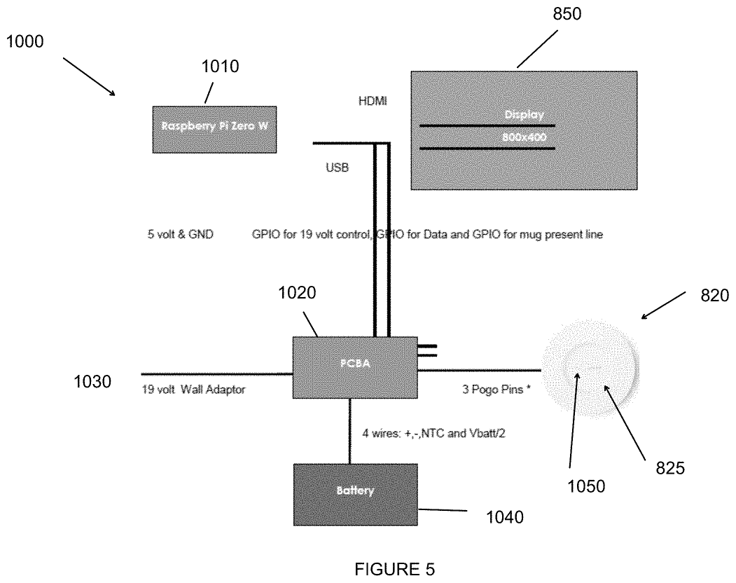

FIG. 3 shows a control unit 800 that extends along two planes, where the visual display 850 extends along a plane that is generally transverse (e.g., perpendicular) to a plane with a base surface 825 that receives the actively heated or cooled drinkware container (e.g., cup, mug) 400. The visual display 800 and base 820 are part of a single integral unit. The visual display 850 can optionally be spaced above the base 820 by an amount that allows the display to be viewed while the actively heated or cooled drinkware container (e.g., cup, mug) 400 is disposed on the base, the visual display 850 optionally disposed to the side of the base surface 825 where the actively heated or cooled drinkware container (e.g., cup, mug) 400 is placed (e.g., docked).

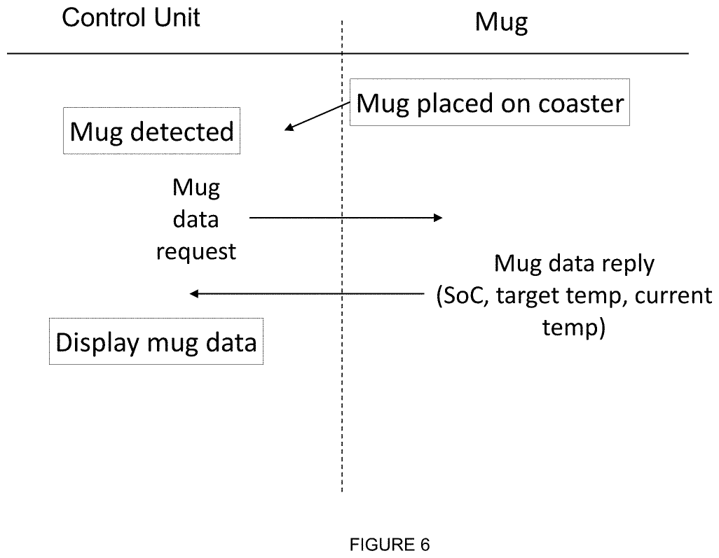

FIG. 4 shows a control unit 800 that includes a separate visual display 850 and base 820, the visual display 850 connected (e.g., electrically connected) to the base 820 by a cable. The base 820 can optionally be in the form of a coaster (e.g., coaster that receives an actively heated or cooled drinkware container (e.g., cup, mug) 400).

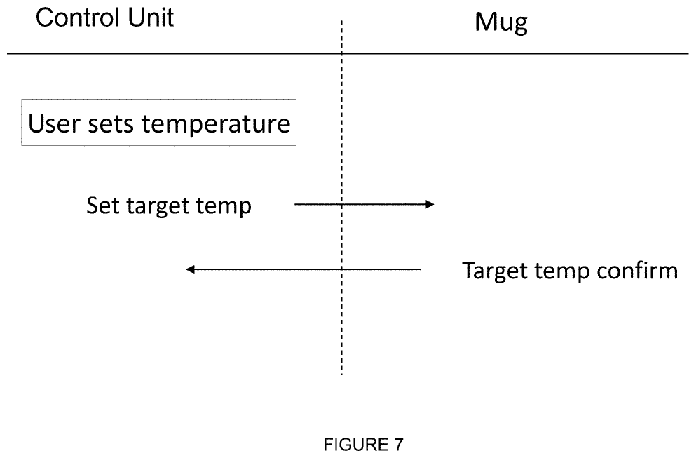

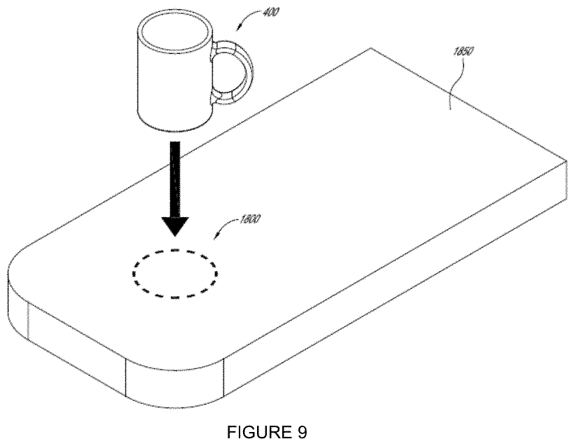

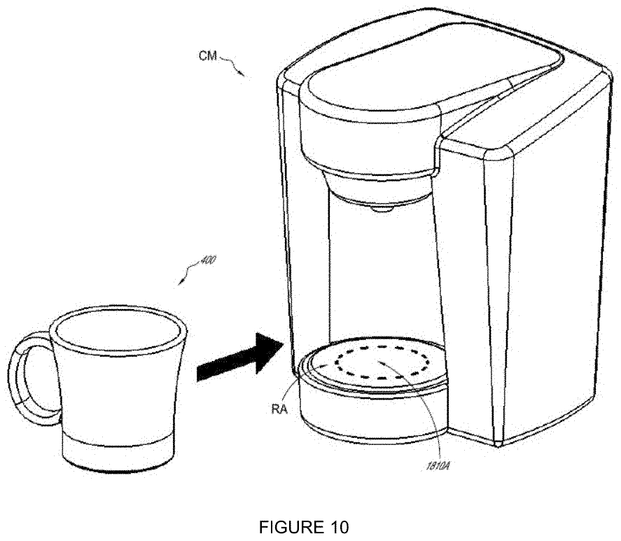

FIG. 5 shows a system block diagram of electronics 1000 in a control unit, such as the implementations of the control unit 800 shown in FIGS. 1-4, and optionally the control unit 1800, 1800A in FIGS. 9-10. The control unit 800, 1800, 1800A can have a visual display 850, circuitry 1010 (e.g., Raspberry Pi Zero W) which can optionally have a wireless LAN and BLUETOOTH® connectivity. The control unit 800, 1800, 1800A can optionally include a printed circuit board assembly (PCBA) 1020 that can electrically communicate with the wall adaptor 1030, one or more optional batteries 1040, and can electrically communicate with the base 820 (e.g., coaster) that receives the actively heated or cooled drinkware container (e.g., cup, mug) 400. The one or more batteries 1040 can be a battery pack (e.g., of two 18650 cells, lithium ion rechargeable batteries). The base surface 825 can optionally have a plurality of electrical contacts 1050 (e.g., three pogo pins) that can connect with two or more electrical connectors (e.g., pair of electrical contact ring) on a bottom of the actively heated or cooled drinkware container (e.g., cup, mug) 400. In another implementation, the electrical contacts 1050 in the base 820 and in the actively heated cup or mug are excluded. In such an implementation, the circuitry 1010 and/or PCBA 1020 of the control unit 800, 1800, 1800A optionally transmits power and/or data (e.g., instructions) to the actively heated or cooled drinkware container (e.g., cup, mug) 400 via inductive coupling (e.g., components in the circuitry 1050 and/or PCBA 1020 in the control unit 800, 1800, 1800A and in the drinkware container, such as cup 400, provide an inductive power transmission circuit).

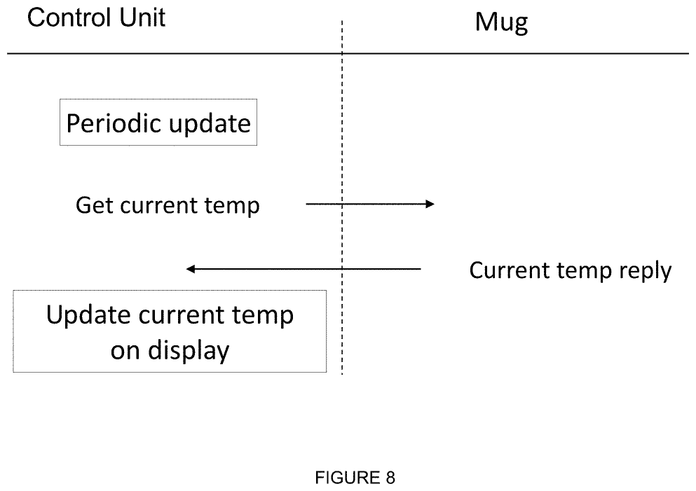

FIGS. 6-8 schematically show communication protocol between the control unit 800, 1800, 1800A and the actively heated or cooled mug or cup 400 when placed on the control unit 800, 1800, 1800A (e.g., when placed on the base surface 825 of the control unit 800, 1800, 1800A). As discussed above, the same communication protocol can be used if another form of actively heated or cooled drinkware device or unit, or another actively heated or cooled dishware or serverware device or unit is used instead of the actively heated mug or cup described herein.

With reference with FIG. 6, when an actively heated or cooled drinkware container (e.g., cup, mug) 400, is placed on the control unit 800, 1800, 1800A, such as on a base surface 825 of the control unit 800, 1800, 1800A, in one implementation, the actively heated or cooled drinkware container (e.g., cup, mug) 400 communicates with the control unit 800, 1800, 1800A in one direction. For example, the control unit 800, 1800, 1800A can send instructions to the actively heated or cooled drinkware container (e.g., cup, mug) 400 to control the operation of the actively heated or cooled drinkware container (e.g., cup, mug) 400. In another implementation, the actively heated or cooled drinkware container (e.g., cup, mug) 400 additionally or alternatively communicates with the control unit 800, 1800, 1800A so as to send data from the actively heated or cooled drinkware container (e.g., cup, mug) 400 to the control unit 800, 1800, 1800A (e.g., two-way communication). For example, the control unit 800, 1800, 1800A can detect the presence of the actively heated or cooled drinkware container (e.g., cup, mug) 400 (as further described below) and can communicate a request for mug data to the actively heated or cooled drinkware container (e.g., cup, mug) 400 (e.g., via the plurality of electrical contacts 1050, such as the pogo pins, of the control unit 800, 1800, 1800A). In reply, the actively heated or cooled drinkware container (e.g., cup, mug) 400 can communicate data (e.g., state of charge of batteries of mug, target temperature currently programmed in mug, current (actual) operating temperature of mug) to the control unit 800, 1800, 1800A.

The visual display 850 of the control unit 800, 1800, 1800A can optionally display one or more of the data it receives from the actively heated or cooled drinkware container (e.g., cup, mug) 400. For example, the visual display 850 can optionally display the target temperature (temperature setpoint) currently programmed into the actively heated or cooled drinkware container (e.g., cup, mug) 400. Optionally, the visual display 850 can display the data it receives from the actively heated or cooled drinkware container (e.g., cup, mug) 400 on one screen, or can allow the toggling through different screens, each screen displaying a different data received from the actively heated or cooled drinkware container (e.g., cup, mug) 400. Where the visual screen displays the current target temperature programmed into the actively heated or cooled drinkware container (e.g., cup, mug) 400, the visual display 850 can also display a temperature slider or temperature scale (see FIG. 1-3). Alternatively, the visual display 850 can display a dial (e.g., circular dial) that the user can rotate with their finger (via the touch screen of the visual display 850).

With reference to FIG. 7, the user can change the target temperature that is programmed into the actively heated or cooled drinkware container (e.g., cup, mug) 400 via the visual display 850. For example, the user can slide their finger on the temperature slider (or on a temperature dial displayed on the visual display 850) to select a different temperature setpoint (e.g., select a temperature between a range of about 120 F-150 F). The new target temperature (e.g., temperature setpoint) is communicated (e.g., immediately communicated) by the control unit 800, 1800, 1800A to the actively heated or cooled drinkware container (e.g., cup, mug) 400 (e.g., via the electrical contacts of the base of the control unit that contact electrical contacts on the mug, via inductive coupling) as the user moves their finger on the temperature slider (or temperature dial, etc.). Optionally, the actively heated or cooled drinkware container (e.g., cup, mug) 400 communicates a signal to the control unit 800, 1800, 1800A to confirm the newly set target temperature, and the control unit 800, 1800, 1800A can optionally display an indication (e.g., message, such as “success!”; symbol, such as √, etc.) on the visual display 850 to confirm the change has been made. When the actively heated or cooled drinkware container (e.g., cup, mug) 400 is removed from the control unit 800, 1800, 1800A, the drinkware container (e.g., cup, mug) 400 will then operate at the newly set target temperature until a new target temperature is programmed into the actively heated or cooled drinkware container (e.g., cup, mug) 400 (e.g., via the control unit 800, 1800, 1800A).

With reference to FIG. 8, the control unit 800, 1800, 1800A can be used to view the current operating temperature of the actively heated or cooled drinkware container (e.g., cup, mug) 400 by placing the drinkware container (e.g., cup, mug) 400 on the control unit 800, 1800, 1800A. For example, when the drinkware container (e.g., cup, mug) 400 is placed back on the control unit 800, 1800, 1800A after it has previously been programmed with the control unit 800, 1800, 1800A, the control unit 800, 1800, 1800A can request (via its electronics) data from the drinkware container (e.g., cup, mug) 400 regarding the current operating temperature, and the drinkware container (e.g., cup, mug) 400 can communicate its current operating temperature to the control unit 800, 1800, 1800A, which can then display the received current operating temperature on the visual display 850. The control unit 800, 1800, 1800A can therefore be used to monitor the current operation of the drinkware container (e.g., cup, mug) 400 (e.g., how close it is to achieving the target temperature).

Although some of the implementations disclosed herein describe the control unit as a standalone portable unit that can receive a drinkware container (e.g., mug) thereon, one of skill in the art will recognize that the control unit 800, 1800, 1800A is not limited to such form factors. As shown in FIG. 9, in one implementation the control unit can be a control unit 1800 embedded in a table, counter or other surface 1850 (e.g., at a restaurant, bar, café, waiting lounge, travel compartment, room service delivery cart or tray, etc.). The actively heated mug 400 can be placed on the control unit 1800 and a separate interface (e.g., on another portion of the surface 1850, or on a separate remote location, such as a separate counter, such as pay counter at a bar, café or restaurant, etc.) can be used to operate the control unit 1800 (e.g., set the temperature in the drinkware container 400 via the control unit 1800). Optionally, the control unit 1800 can include a recessed surface sized to at least partially receive a portion of the drinkware container (e.g., cup, mug) 400 therein. Optionally, the control unit 1800 can have one or more electrical contacts that can contact one or more electrical contacts on a portion or surface of the drinkware container (e.g., cup, mug) 400 to electrically connect the control unit 1800 with the drinkware container (e.g., cup, mug) 400, allowing the control unit 1800 and drinkware container (e.g., cup, mug) 400 to communicate in the various manners described above (e.g., to set the operating temperature of the actively heated or cooled drinkware container (e.g., cup, mug) 400 via the control unit 1800, to charge the one or more batteries of the drinkware container 400, etc.). In another implementation, the control unit 1800 can exclude electrical contacts and can transmit power and information, and optionally receive information from the drinkware container, such as mug 400, via inductive coupling, as discussed previously.

As discussed above in connection with FIG. 5, the control unit 800, 1800, 1800A can in one implementation have three electrical contacts 1050, such as pogo pins, that can contact the electrical contacts on the actively heated or cooled mug or cup 400 (or other drinkware container, dishware unit or serverware unit). In one implementation, the control unit 800, 1800, 1800A has 3 pogo pins and the actively heated or cooled drinkware container (e.g., cup, mug) 400 has two electrical contact rings. Two of the pogo pins can contact one of the contact rings and the third pogo pin would contact the other contact ring. For example, the two pogo pins would contact the outer contact ring (e.g., the ground ring) and the third pogo pin would contact the inner contact ring of the mug. The third pogo pin that contacts the outer ring, when depressed would have a resistor pulling up to the power rail. Voltage would sit at 3.3 V and the signal is connected to a processor in the circuitry 1010 (e.g., the Raspberry Pi (general purpose input/output or GPIO), ARM+Digital Signal Processors (DSP) Systems-on-Chip (SoC) CPU, etc.). When the drinkware container (e.g., cup, mug) 400 is placed on the control unit 800, 1800, 1800A (e.g., on the base surface 825 of the control unit that has the three pogo pins), the outer ring would short the two pogo pins together, pulling the voltage on the sensed pin low, which the circuitry 1010 (e.g., Raspberry Pi) recognizes as the signal indicating drinkware container (e.g., cup, mug) 400 has been placed on the control unit 800, 1800, 1800A. The circuitry 1010 (e.g., Raspberry Pi) can then begin receiving the data from the mug 400 (see FIG. 6).

The data is communicated between the control unit 800, 1800, 1800A (e.g., control unit in FIGS. 1-3) and the actively heated or cooled drinkware container (e.g., cup, mug) 400 (e.g., circuitry in the actively heated or cooled mug or cup) using two of the three pogo pins (one that contacts the outer contact ring, and the second one that contacts the inner contact ring).

Data transfer between the control unit 800, 1800, 1800A and the actively heated or cooled drinkware container (e.g., cup, mug) 400 is initiated by sending a voltage sequence (on-off-on-off), or pulse train (e.g., connect and disconnect voltage a set number of times or cycles) having a certain pattern, from the control unit 800, 1800, 1800A to the drinkware container (e.g., cup, mug) 400 (via the two pogo pins). Software in the drinkware container (e.g., cup, mug) 400 recognizes the pulse train from the control unit 800, 1800, 1800A as indicating the drinkware container (e.g., cup, mug) 400 has been placed on the control unit 800, 1800, 1800A and knows to communicate data (e.g., current operating temperature, current target temperature programmed into drinkware container 400) to the control unit 800, 1800, 1800A (e.g., again via the two pogo pins), and also knows to detect a new target temperature communicated by the control unit 800, 1800, 1800A to the drinkware container (e.g., cup, mug) 400. The drinkware container (e.g., cup, mug) 400 communicates the data to the control unit 800, 1800, 1800A by switching the heating or cooling element on and off (e.g., pulsing the heater on and off) in a certain pattern (for short periods of time). The switching on an off of the heater results in a change in current flow (e.g., current increases when heater is switched on, current decreases when heater is switched off), which the control unit 800, 1800, 1800A detects as a binary code (e.g., again via the two pogo pins).

The control unit 800, 1800, 1800A interprets the binary code provided by the change in current flow due to the switching of the heater on and off to receive the data (e.g., current operating temperature, current target temperature programmed into the drinkware container 400) from the drinkware container (e.g., cup, mug) 400. The control unit 800, 1800, 1800A communicates a new target temperature setpoint to the drinkware container (e.g., cup, mug) 400 by pulsing voltage on-off in a certain pattern that the drinkware container (e.g., cup, mug) 400 recognizes and interprets as a new target temperature setpoint. The drinkware container (e.g., cup, mug) 400 senses voltage at a certain interval and detects at said intervals whether there is a voltage being communicated from the control unit 800, 1800, 1800A or not, and interprets such presence or absence of voltage as a binary code that communicates a new target temperature setpoint for the drinkware container (e.g., cup, mug) 400 to use to which the one or more heating elements will operate to heat a liquid in the drinkware container (e.g., cup, mug) 400.

In another implementation, data transfer from the control unit 800, 1800, 1800A to the actively heated or cooled drinkware container (e.g., cup, mug) 400 is accomplished by varying voltage levels, rather than turning voltage on and off to send data (e.g., instructions) from the control unit 800, 1800, 1800A to the actively heated or cooled drinkware container (e.g., cup, mug) 400. In another implementation, data transfer from the actively heated or cooled drinkware container (e.g., cup, mug) 400 to the control unit 800, 1800, 1800A is accomplished by varying current levels, rather than turning current on and off, to send data (e.g., actual sensed temperature, current operating temperature setpoint) from the actively heated or cooled drinkware container (e.g., cup, mug) 400 to the control unit 800, 1800, 1800A.

In another embodiment, shown in FIG. 10, a control unit 1810A, similar to the control unit 800, 1800, can optionally be attached to, coupled to, embedded in or otherwise incorporated in a container receiving area RA of a beverage preparation and/or dispensing machine CM (e.g., a single-serving coffee machine, or coffee machine with a carafe, etc.). When the actively heated or cooled drinkware container 400, such as the actively heated or cooled cup or mug, is placed on the receiving area RA of the machine CM it can sit over the control unit 1800, which can transmit power and/or information (e.g., temperature setpoints) and optionally receive information from the drinkware container, in the manner described above in connection with FIGS. 1-9.

### Additional Embodiments

In embodiments of the present invention, a control unit for use with an actively heated or cooled drinkware, dishware or serverware device may be in accordance with any of the following clauses:
Clause 1. A control unit for an actively heated or cooled drinkware, dishware or serverware device, comprising:
   a base having a surface configured to receive the actively heated or cooled drinkware, dishware or serverware device thereon;
   a visual display; and
   circuitry configured to communicate with the visual display, the circuitry being operable to perform one or more of:
      send a data request signal to the device,
      receive one or more data from device,
      receive one or more operating parameter setpoints from a user;
      send the one or more operating parameter setpoints to the device to set a new target value for the one or more operating parameter setpoints at which the device is to operate, and
      communicate at least one of the one or more data to the visual display to display said at least one data on the visual display.
Clause 2. The control unit of clause 1, further comprising one or more electrical contacts on the surface configured to contact one or more electrical contacts on a surface of the drinkware, dishware or serverware device when the device is placed on the surface, the circuitry configured to communicate with the one or more electrical contacts on the surface of the base, where the circuitry is operable to send the data request signal to the device via the one or more electrical contacts on the surface of the base, receive the one or more data from the device via the one or more electrical contacts on the surface of the base, and send the one or more operating parameter setpoints to the device via the one or more electrical contacts on the surface of the base.
Clause 3. The control unit of clause 1, wherein the visual display is a touch screen, the circuitry configured to receive the one or more operating parameter setpoints from the user via the touch screen.
Clause 4. The control unit of any preceding clause, wherein the base and the visual display are separate components that are interconnected by a cable.
Clause 5. The control unit of any preceding clause, wherein the base is in the shape of a coaster.
Clause 6. The control unit of clause 1, wherein the base and the visual display are part of an integral unit.
Clause 7. The control unit of any preceding clause, wherein the data includes one or more of a state of charge of one or more batteries of the device, a current operating temperature of the device, and a current operating temperature setpoint of the device.
Clause 8. The control unit of any preceding clause, wherein the one or more operating parameter setpoints is an operating temperature setpoint for the device.
Clause 9. The control unit of any preceding clause, wherein the circuitry sends a data request signal to the device via the one or more electrical contacts on the surface of the base by sending a pulsed voltage signal to the device via the one or more electrical contacts on the surface of the base.
Clause 10. The control unit of any preceding clause, wherein the circuitry receives the one or more data from device via the one or more electrical contacts on the surface of the base in the form of a signal of pulsed current flow effected by turning off and on one or more heating or cooling elements in the device, the circuitry configured to interpret the pulsed current flow signal as binary code to interpret the received data.
Clause 11. The control unit of any preceding clause, wherein the circuitry sends the one or more operating parameter setpoints to the device via the one or more electrical contacts in the form of a pulsed voltage signal that circuitry in the device interprets as a binary code to interpret the sent operating parameter setpoints.
Clause 12. The control unit of any preceding clause, wherein the one or more electrical contacts on the surface of the base are three pogo pins, where two of the pogo pins are configured to contact one electrical contact ring of the device, and the third pogo pin is configured to contact another electrical contact ring of the device.
Clause 13. The control unit of clause 12, wherein the circuitry of the control unit detects that the device has been placed on the base via a signal generated by the contact of the two pogo pins with said one electrical contact ring of the device.
Clause 14. In combination, the control unit of any preceding clause incorporated into a table, stand or counter surface.
Clause 15. In combination, the control unit of any preceding clause incorporated into a beverage preparation and dispensing machine.

While certain embodiments of the inventions have been described, these embodiments have been presented by way of example only, and are not intended to limit the scope of the disclosure. Indeed, the novel methods and systems described herein may be embodied in a variety of other forms. For example, though the features disclosed herein are in describe for drinkware containers, the features are applicable to containers that are not drinkware containers (e.g., dishware, such as plates and bowls, serverware such as serving dishes and hot plates, food storage containers such as tortilla warmers, bread baskets) and the invention is understood to extend to such other containers, or to other drinkware container types (e.g., cups, mugs, water bottles, carafes, wine glasses, water jugs). Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A control unit for an actively heated or cooled drinkware, dishware or serverware device, comprising:
a base having a surface configured to receive the actively heated or cooled drinkware, dishware or serverware device thereon;
a visual display; and
circuitry configured to communicate with the visual display, the circuitry being operable to perform one or more of:
send a data request signal to the device,
receive one or more data from device,
receive one or more operating parameter setpoints from a user;
send the one or more operating parameter setpoints to the device to set a new target value for the one or more operating parameter setpoints at which the device is to operate, and
communicate at least one of the one or more data to the visual display to display said at least one data on the visual display.

2. The control unit of claim 1, further comprising one or more electrical contacts on the surface configured to contact one or more electrical contacts on a surface of the drinkware, dishware or serverware device when the device is placed on the surface, the circuitry configured to communicate with the one or more electrical contacts on the surface of the base, where the circuitry is operable to send the data request signal to the device via the one or more electrical contacts on the surface of the base, receive the one or more data from the device via the one or more electrical contacts on the surface of the base, and send the one or more operating parameter setpoints to the device via the one or more electrical contacts on the surface of the base.

3. The control unit of claim 1, wherein the visual display is a touch screen, the circuitry configured to receive the one or more operating parameter setpoints from the user via the touch screen.

4. The control unit of claim 1, wherein the base and the visual display are separate components that are interconnected by a cable.

5. The control unit of claim 1, wherein the base is in the shape of a coaster.

6. (canceled)

7. The control unit of claim 1, wherein the data includes one or more of a state of charge of one or more batteries of the device, a current operating temperature of the device, and a current operating temperature setpoint of the device.

8. The control unit of claim 1, wherein the one or more operating parameter setpoints includes an operating temperature setpoint for the device.

9. The control unit of claim 2, wherein the circuitry sends a data request signal to the device via the one or more electrical contacts on the surface of the base by sending a pulsed voltage signal to the device via the one or more electrical contacts on the surface of the base.

10. The control unit of claim 2, wherein the circuitry receives the one or more data from device via the one or more electrical contacts on the surface of the base in the form of a signal of pulsed current flow effected by turning off and on one or more heating or cooling elements in the device, the circuitry configured to interpret the pulsed current flow signal as binary code to interpret the received data.

11. The control unit of claim 2, wherein the circuitry sends the one or more operating parameter setpoints to the device via the one or more electrical contacts in the form of a pulsed voltage signal that circuitry in the device interprets as a binary code to interpret the sent operating parameter setpoints.

12. The control unit of claim 2, wherein the one or more electrical contacts on the surface of the base include three pogo pins, where two of the pogo pins are configured to contact a first electrical contact ring of the device, and the third pogo pin is configured to contact a second electrical contact ring of the device.

13. The control unit of claim 12, wherein the circuitry of the control unit detects that the device has been placed on the base via a signal generated by the contact of the two pogo pins with said first electrical contact ring of the device.

14. (canceled)

15. (canceled)

16. A control unit for an actively heated or cooled drinkware, dishware or serverware device, comprising:
a base having a surface configured to receive the actively heated or cooled drinkware, dishware or serverware device thereon;
an electronic display; and
circuitry configured to communicate with the electronic display, the circuitry being operable to perform one or more of:
send a data request signal to the actively heated or cooled drinkware, dishware or serverware device when the actively heated or cooled drinkware, dishware or serverware device is disposed on the base,
receive one or more data from the actively heated or cooled drinkware, dishware or serverware device when the actively heated or cooled drinkware, dishware or serverware device is disposed on the base,
send the one or more operating parameter setpoints to the actively heated or cooled drinkware, dishware or serverware device to set a new target value for the one or more operating parameter setpoints therefor when the actively heated or cooled drinkware, dishware or serverware device is disposed on the base, and
communicate at least one of the one or more data to the electronic display to display said at least one data on the electronic display,
wherein the data includes one or more of a state of charge of one or more batteries, a current operating temperature, and a current operating temperature setpoint of the actively heated or cooled drinkware, dishware or serverware device.

17. The control unit of claim 16, further comprising one or more electrical contacts on the surface configured to contact one or more electrical contacts on a surface of the drinkware, dishware or serverware device when the actively heated or cooled drinkware, dishware or serverware device is placed on the surface, the circuitry configured to communicate with the one or more electrical contacts on the surface of the base, where the circuitry is operable to send the data request signal to the actively heated or cooled drinkware, dishware or serverware device via the one or more electrical contacts on the surface of the base, receive the one or more data from the actively heated or cooled drinkware, dishware or serverware device via the one or more electrical contacts on the surface of the base, and send the one or more operating parameter setpoints to the actively heated or cooled drinkware, dishware or serverware device via the one or more electrical contacts on the surface of the base.

18. The control unit of claim 16, wherein the base and the visual display are separate components that are interconnected by a cable.

19. The control unit of claim 16, wherein the base is in the shape of a coaster.

20. The control unit of claim 16, wherein the one or more operating parameter setpoints is an operating temperature setpoint for the device.

21. The control unit of claim 17, wherein the circuitry sends a data request signal to the device via the one or more electrical contacts on the surface of the base by sending a pulsed voltage signal to the device via the one or more electrical contacts on the surface of the base.

22. The control unit of claim 17, wherein the circuitry receives the one or more data from device via the one or more electrical contacts on the surface of the base in the form of a signal of pulsed current flow effected by turning off and on one or more heating or cooling elements in the device, the circuitry configured to interpret the pulsed current flow signal as binary code to interpret the received data.

23. The control unit of claim 17, wherein the circuitry sends the one or more operating parameter setpoints to the device via the one or more electrical contacts in the form of a pulsed voltage signal that circuitry in the device interprets as a binary code to interpret the sent operating parameter setpoints.
